(19) United States
(12) Patent Application Publication
(10) Pub. No.: US 2017/0220678 A1
(43) Pub. Date: Aug. 3, 2017

(54) AUTOMATED SCIENTIFIC ERROR CHECKING

(71) Applicant: Oklahoma Medical Research Foundation, Oklahoma City, OK (US)

(72) Inventor: Jonathan Daniel Wren, Norman, OK (US)

(21) Appl. No.: 15/420,303

(22) Filed: Jan. 31, 2017

Related U.S. Application Data
(60) Provisional application No. 62/289,717, filed on Feb. 1, 2016.

(51) Int. Cl. G06F 17/30

(52) U.S. Cl. CPC G06F 17/30705; G06F 17/30716

(57) ABSTRACT

The present invention includes a computerized method and non transitory computer readable medium that includes a code for determining errors within a text file in electronic format, the method comprising: obtaining an electronic file of the publication; identifying one or more possible errors in the electronic file using a processor; sorting the possible errors in the electronic file into one or more error categories; based on the error category, performing one or more of the following: (1) checking calculations on numerical errors, (2) checking an availability of cited external references, (3) statistical calculations, (4) determining consistent use of terminology, (5) checking nomenclature, or (6) identifying appropriate use of statistical tests; sorting possible errors into confirmed errors or corrected values for each possible error; and at least one of storing or displaying the confirmed errors.

### CROSS-REFERENCE TO RELATED APPLICATIONS

This application claims priority to U.S. Provisional Application Ser. No. 62/289,717, filed Feb. 1, 2016, the entire contents of which are incorporated herein by reference.

### STATEMENT OF FEDERALLY FUNDED RESEARCH

This invention was made with government support under ACI-1345426 awarded by National Science Foundation and U54GM104938, and P20GM103636 awarded by the NIH. The government has certain rights in the invention.

### TECHNICAL FIELD OF THE INVENTION

The present invention relates in general to the field of electronic documents, and more particularly, to an automated error checking method for use by, e.g., authors, reviewers and journals for correcting errors prior to, or after, publication.

### BACKGROUND OF THE INVENTION

Without limiting the scope of the invention, its background is described in connection with error correction in electronic documents.

U.S. Pat. No. 9,110,882, issued to Overell, et al., entitled “Extracting structured knowledge from unstructured text”, is said to teach knowledge representation systems that include a knowledge base in which knowledge is represented in a structured, machine-readable format that encodes meaning. Techniques for extracting structured knowledge from unstructured text and for determining the reliability of such extracted knowledge are also described.

U.S. Pat. No. 9,015,098, issued to Crosley, entitled “Method and system for checking the consistency of established facts within internal works”, is said to teach systems and methods for checking the consistency of established facts within internal works by identifying established facts within the internal works and determining whether any of the established facts are contradictory to one another. Facts may be established and conflicts may be identified by any means, such as by determining associations between words of the internal work, or by consulting one or more external resources. If a contradiction between established facts is identified, then an author of the internal work or other user may be notified, and a change to the internal work may be recommended to the author or user, or requested from the author or user.

U.S. Pat. No. 8,713,031, issued to Lee, entitled “Method and system for checking citations” is said to teach a method that lexically analyzes and parses a citation. The method may identify errors in the citation, and may optionally interpret and display semantic information. The method may optionally suggest corrections to errors.

### SUMMARY OF THE INVENTION

In one embodiment, the present invention includes a computerized method for determining errors within the text of a file in electronic format, the method comprising: obtaining an electronic file of the text; identifying one or more possible errors in the electronic file using a processor; sorting the possible errors in the electronic file into one or more error categories; based on the error category, performing one or more of the following: (1) calculations on provided numbers for mathematical errors, (2) checking at least one of the status, availability, or key content accuracy of cited external references, (3) checking a name or reference to a statistical test performed, extracting the reported values and re-conducting the statistical test to compare the accuracy of the re-calculated values with the reported values, (4) determining consistent use of terminology, (5) comparing nomenclature employed in the document with at least one of a standardized nomenclature or a commonly employed nomenclature; or (6) identifying an appropriate use of statistical tests; sorting possible errors into confirmed errors or corrected values for each possible error; and at least one of storing or displaying the confirmed errors. In one aspect, the step of performing calculations on numerical errors is defined further as comprising identifying a set of numbers or terms reported in the electronic file, determining a mathematical relationship between the set of numbers or terms, and re-calculating the values of a set of numbers or terms reported in the electronic file, wherein a discrepancy in the calculation causes the possible error to become a confirmed numerical error. In another aspect, the step of performing statistical calculations by checking a reported number in relation to its confidence interval, extracting values, and processing them with the statistical routine, and comparing reported values to calculated values, wherein a discrepancy in the statistical calculation causes the possible error to become a confirmed statistical calculation error. In another aspect, the step of performing the step of checking at least one of the status, availability, or key content accuracy of cited external references includes one or more of the following: URL accessibility, DOI validity, clinical trials number existence and accuracy, wherein a discrepancy in the availability of the cited external references causes the possible error to become a confirmed cited external references calculation error. In another aspect, the step of performing the step of checking at least one of the status, availability, or key content accuracy of cited external references may further include one or more of the following: confirmation of the existence of the external reference; confirmation of the correct format of the external reference; or confirmation of the validity of the cited portion of the text of the external reference. In another aspect, the step of performing the step of determining consistent use of terminology comprises determining consistent numbers associated with terms related to sample size, cohorts, controls, wherein a discrepancy in the availability of the consistent use of terminology causes the possible error to become a confirmed cited external references calculation error. In another aspect, the step of performing the step of comparing nomenclature employed in the document with at least one of a standardized nomenclature or a commonly employed nomenclature is defined further as determining standardization or conformity with best practices in chemical names, non-standard gene names, and indexing, and calculating a degree of acceptable variation in their spelling, wherein a discrepancy in the availability of the consistent use of nomenclature causes the possible error to become a confirmed cited external references calculation error. In another aspect, the step of performing calculations on provided numbers for mathematical errors is defined further as comprising identifying a set of numbers or terms reported in the electronic file, determining a mathematical relationship between the set of numbers or terms, and re-calculating the values for set of numbers or terms reported in the electronic file, wherein a discrepancy in the calculation causes the possible error to become a confirmed numerical error. In another aspect, the step of checking the name or reference to a statistical test performed, extracting the reported values and re-conducting the statistical test to compare the accuracy of the re-calculated values with the reported values is defined further as checking a reported number in relation to its confidence interval, extracting values, and processing them with the statistical routine, and comparing reported values to calculated values, wherein a discrepancy in the statistical calculation causes the possible error to become a confirmed statistical calculation error.

In another embodiment, the present invention includes a non-transitory computer readable medium for determining errors within a text file in an electronic format or an image of a file and converting it into electronic format, comprising instructions stored thereon, that when executed by a computer having a communications interface, one or more databases and one or more processors communicably coupled to the interface and one or more databases, perform the steps comprising: obtaining from the one or more databases an electronic file of the text file; identifying one or more possible errors in the electronic file using a processor; sorting the possible errors in the electronic file into one or more error categories; performing one or more of the following: (1) calculations on provided numbers for mathematical errors, (2) checking at least one of the status, availability, or key content accuracy of cited external references, (3) checking a name or reference to a statistical test performed, extracting the reported values and re-conducting the statistical test to compare the accuracy of the re-calculated values with the reported values, (4) determining consistent use of terminology, (5) comparing nomenclature employed in the document with at least one of a standardized nomenclature or a commonly employed nomenclature, or (6) identifying an appropriate use of statistical tests; sorting possible errors into confirmed errors or corrected values for each possible error; and at least one of storing or displaying the confirmed errors. In one aspect, the step of performing calculations on numerical errors is defined further as comprising identifying a set of numbers or terms reported in the electronic file, determining a mathematical relationship between the set of numbers or terms, and re-calculating the values of a set of numbers or terms reported in the electronic file, wherein a discrepancy in the calculation causes the possible error to become a confirmed numerical error. In another aspect, the step of performing statistical calculations by checking a reported number in relation to its confidence interval, extracting values, and processing them with the statistical routine, and comparing reported values to calculated values, wherein a discrepancy in the statistical calculation causes the possible error to become a confirmed statistical calculation error. In another aspect, the step of performing the step of checking at least one of the status, availability, or key content accuracy of cited external references includes one or more of the following: URL accessibility, DOI validity, clinical trials number existence and accuracy, wherein a discrepancy in the availability of the cited external references causes the possible error to become a confirmed cited external references calculation error. In another aspect, the step of performing the step of checking at least one of the status, availability, or key content accuracy of cited external references may further include one or more of the following: Confirmation of the existence of the external reference; confirmation of the correct format of the external reference; or confirmation of the validity of the cited portion of the text of the external reference. In another aspect, the step of performing the step of determining consistent use of terminology comprises determining consistent numbers associated with terms related to sample size, cohorts, controls, wherein a discrepancy in the availability of the consistent use of terminology causes the possible error to become a confirmed cited external references calculation error. In another aspect, the step of performing the step of comparing nomenclature employed in the document with at least one of a standardized nomenclature or a commonly employed nomenclature is defined further as determining standardization or conformity with best practices in chemical names, non-standard gene names, and indexing, and calculating a degree of acceptable variation in their spelling, wherein a discrepancy in the availability of the consistent use of nomenclature causes the possible error to become a confirmed cited external references calculation error. In another aspect, the step of performing calculations on provided numbers for mathematical errors is defined further as comprising identifying a set of numbers or terms reported in the electronic file, determining a mathematical relationship between the set of numbers or terms, and re-calculating the values for set of numbers or terms reported in the electronic file, wherein a discrepancy in the calculation causes the possible error to become a confirmed numerical error. In another aspect, the step of checking the name or reference to a statistical test performed, extracting the reported values and re-conducting the statistical test to compare the accuracy of the re-calculated values with the reported values is defined further as checking a reported number in relation to its confidence interval, extracting values, and processing them with the statistical routine, and comparing reported values to calculated values, wherein a discrepancy in the statistical calculation causes the possible error to become a confirmed statistical calculation error. In another aspect, the step of converting the image of a file into an electronic format is by object character recognition. In another aspect, the step of converting the image of a file into an electronic format is by object character recognition in which the language of the publication is first detected, and once the language is identified performing object character recognition for that language.

### BRIEF DESCRIPTION OF THE DRAWINGS

For a more complete understanding of the features and advantages of the present invention, reference is now made to the detailed description of the invention along with the accompanying figures and in which:

FIG. 1 is an example of a flowchart for checking text for mathematical errors in documents.

FIG. 2 is an example of a flowchart for checking text for statistical errors in documents.

FIG. 3 is an example of a flowchart for checking text for errors in external references.

FIG. 4 is an example of a flowchart for checking text for errors in internal document consistency.

FIG. 5 is an example of a flowchart for checking text for optimized nomenclature and potential nomenclature errors.

FIG. 6 is an example of a flowchart for checking text for use of appropriate statistical methods.

FIG. 7 is a scatterplot with a comparison of reported vs recalculated percent-ratio pairs in log 10 scale. Likely decimal errors are evident in the offset diagonals. A density plot of how many reported observations of each value is shown at bottom.

FIG. 8 is a scatterplot of reported versus re-calculated values for ratios (Odds Ratio, Hazard Ratio and Relative Risk) and their 95% Confidence Intervals (CIs) in log 10 scale. Shown at bottom is a density plot reflecting the number of observations within that range of reported values.

FIG. 9 is a histogram of the number of discrepancies found in ratio-CI calculations versus their magnitude. Small discrepancies are disproportionately more common than large ones. Misplacement or omission of decimal places can lead to large discrepancies, which is a part of the spike that appears at >=100%.

FIG. 10 is a scatterplot with a comparison of reported p-values versus their recalculated values, based upon their 95% CIs. Red asterisks indicate instances where there was a discrepancy between the reported and recalculated ratio-CI, suggesting potential causality for a discrepancy. 87% of all reported p-values were p<=0.05, as can be seen in the density histogram, which was truncated at 12,000 (36,420 p-values were <0.01).

FIG. 11 is a scatterplot with a reported versus re-calculated p-values shown on a log 10 scale with density histogram at bottom.

FIG. 12A is a graph that shows a correlation between JIF and error rate. The error rate decreases for all item types decreases as JIF increases.

FIG. 12B is a graph that shows conditioning the model to subtract out the influence of the number of authors on the error rate dependence. Curves are derived with smoothing splines, showing the average error rate at each point.

FIG. 13A is a graph that shows a correlation between error rate and the number of authors per paper. The addition of more authors to a paper is correlated with a reduced error rate.

FIG. 13B is a graph that shows conditioning for the impact of JIF on error rate. For each fixed number of authors, curves show the average error rate, derived with smoothing splines.

FIG. 14A is a graph that shows error rates for each analyzed item type since 1990. Error rates seem to be slowly declining for several item types, except HR, which is rising, and percent-ratio pair errors have remained flat. HR is a relatively recent item type, with the first detected report in 1989, but it wasn't until approximately 1998 that the number of reported HRs began rapidly rising.

FIG. 14B is a graph that shows conditioning out the effects of both JIF and author number. Curves are derived with smoothing splines, showing the average error rate at each point.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

Errors make it into published scientific reports for a variety of reasons, and vary in their importance. Beginning with the less important, minor misspellings or formatting errors in Uniform Resource Locator (URL) or Digital Object Identifier (DOI) links to online resources might yield a “404 not found” error. This causes less trouble because many people are familiar with URL formats and might be able to spot the problem and correct it themselves (e.g., a *.org domain misspelled as *.ogr) or Google the resource and find the correct URL. On a more substantive level, errors in reported percent-ratio pairs (e.g., “4/6 patients (50%) responded to treatment”) raise the question about which number is the correct result that was intended to be reported, because 4/6 does not equal 50%. Reading the paper further may or may not clarify the issue and, if not, it cannot be resolved except by contacting the authors, who may or may not respond or clarify. Similarly, statistical tests involving confidence intervals (CI) are designed to assign a probability estimate of the true mean being between the bounds of the intervals. In odds ratio (OR) tests, one can log transform the values and see if the reported OR matches the reported CI. If they don't, then it casts doubt on whether or not the authors drew the correct conclusions based on that statistical test or even that they conducted the exact test they claimed to.

Over the years, the inventor(s) have conducted a number of analyses on MEDLINE records, and found a number of errors that fall into each of these categories, but the scope of the invention extends to any published report of a scientific, academic or technical nature. The central idea behind this invention is to design a set of algorithms to identify when each kind of error might occur, then to identify and extract the appropriate values from the text for checking, and then validate the correctness of the reported result. The invention can proceed either from first principles (e.g., knowing how a test is conducted, such as requiring normally distributed data to correctly calculate a p-value, the test can be reconstructed algorithmically by extracting key parameters. Even though the necessary steps to re-perform the analysis are generally not explicitly stated within the document itself, they are available through other sources such as statistics textbooks or online resources) or it can be done by automated re-analysis of the data based on the values reported (e.g., recalculating a ratio based on the author-provided numerator and denominator, whereby all necessary parameters are provided in the document itself).

The invention could be implemented as an online web server, whereby parties of interest (e.g., researchers, reviewers or journal editors) could upload or cut and paste the text to be analyzed, and a report of all potential scientific and statistical errors found within the document generated and summarized for checking. The invention deals, specifically, with detecting scientific, statistical or technical errors of procedure, calculation or reference. It is different from and does not encompass error-checking routines based upon spelling dictionaries or grammatical patterns (e.g., functions commonly found in word processing software).

To date, solutions exist to check spelling and grammar, but nothing currently exists to automatically scan a paper and check for errors of a technical nature. The present invention solves the problem of unintended errors creeping into the published record. The present invention also provides a method for technically checking calculations and statistics that might suggest the authors did not use an appropriate statistical method or did not report the results correctly and the conclusions drawn from the calculations or statistics could be invalid. The present invention also solves the problem of automating this error-checking process, which is needed because reviewers rarely re-calculate the results as shown by the rate of existing errors in MEDLINE.

The present invention is a resource whereby authors, reviewers and journals could check the text of an electronic document, such as paper or manuscript accepted for publication, including the text of figures, before or after publication, for potential errors that fall into a number of categories ranging from benign mistakes that should be corrected by the authors but do not otherwise impact the logic or conclusions of the publication, to more serious problems that raise questions as to whether or not the proper conclusions were drawn, proper procedures were followed, or proper data was reported. This resource could be instantiated either as a program that could be copied/downloaded, or it could be implemented as a web server on the World Wide Web. One way the invention could be used is to support the checking of manuscripts either before or during the first phase of peer-review, whereby authors could see the potential errors detected by the method and address them prior to publication. Another way would be for people to identify potential errors in papers after they have been published, which would alert them to potential problems of reproducibility before they spend their own time and money to replicate or build on the results. Because of the rapidly increasing publication of papers, reviewers are often pressed for time and will not generally check things that are presumed to be relatively straightforward to calculate or report correctly, unless the reported values are obviously wrong to a casual observer. For example, if someone reported a ratio-percent pair of 4/6 (50%), it would be easier for the average casual observer to notice that 4/6 does not equal 50% without reliance upon a computer or calculator, but 17/69 (29%) is less obvious (the correct value should be 24.6%) to the average casual observer and less likely to be noticed.

Categories of errors that can be identified algorithmically by the described invention. The specific instantiations of detected errors are not intended to be an exhaustive list, but representative of the errors that either have been or could be detected algorithmically. The following categories of error detection indicate what the scope of the invention is intended to cover at least one of the following, calculation, statistical procedure, external reference, consistency, and/or standardization or conformity with best practice.

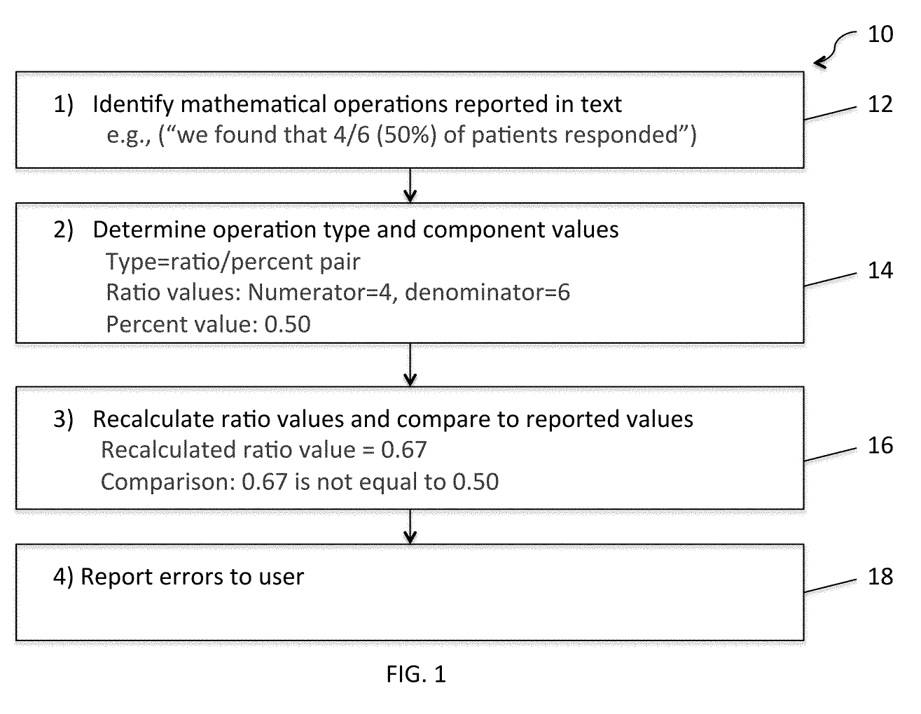

Calculation (e.g., percent-ratio pairs): This type of error can be caught by first identifying a set of numbers or terms reported in the paper, and knowledge of their mathematical relationships enables a re-calculation of their values for comparison. FIG. 1 shows an example of a routine for finding and calculating mathematical errors 10 that can be identified using the present invention. First, a mathematical operation is identified in the text, specifically; the fraction (“4/6”) and a related percentage in the parenthetical “(50%)” are identified. Next, an operation type is determined and the component values are identified, e.g., the type being a combination of a fraction and a percentage, next, the ratio values are determined for the numerator=4, and the denominator=6 and the percentage value assigned to be 0.5. Finally, the ratio values are recalculated (4/6 being 0.67) when compared to 0.50, and the error is reported to the user.

The process for checking for mathematical errors 10 in documents, includes: (Step 12) Identify mathematical operations reported in text (e.g., “we found that 4/6 (50%) of patients responded”); (Step 14) Determine operation type and component values (e.g.: Type=ratio/percent pair; Ratio values: Numerator=4, denominator=6; and/or Percent value: 0.50); (Step 16) Recalculate ratio values and compare to reported values (e.g.: Recalculated ratio value=0.67 and/or Comparison: 0.67 is not equal to 0.50); and (Step 18) Report errors to user.

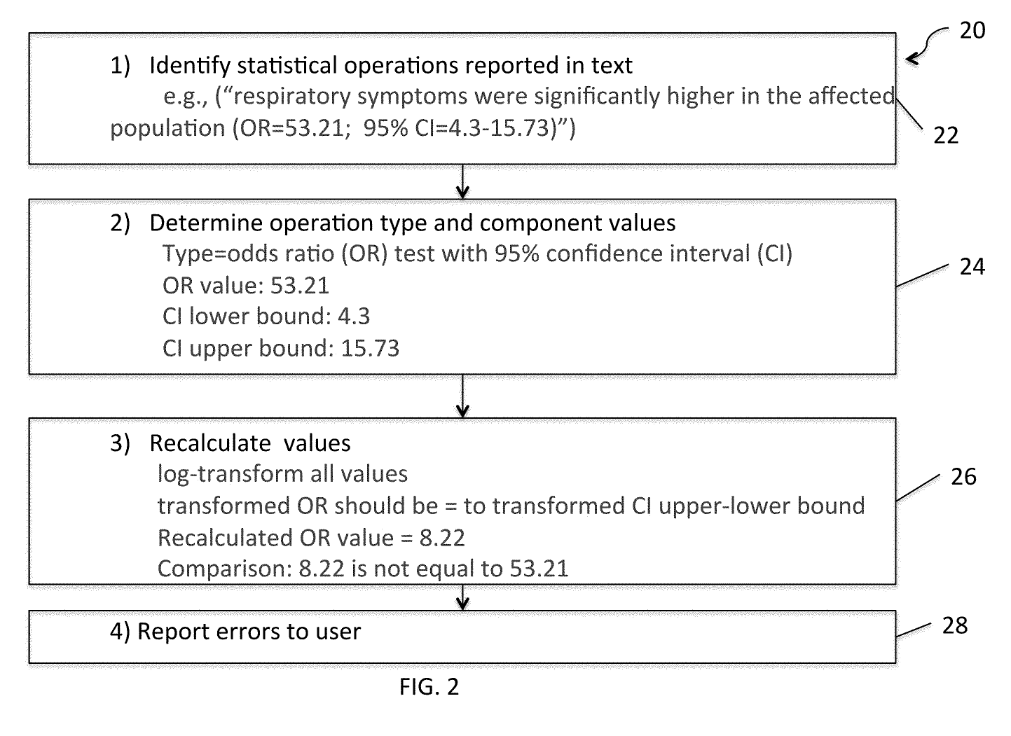

Statistical procedure (e.g., checking a reported Odds Ratio number is correct given its stated Confidence Interval): Similar to detection of calculation-based errors, but requires a routine to re-run a statistical analysis that itself is not provided in the paper, but is based on best practice and can be obtained from common sources of statistical knowledge (e.g., textbooks). The error checking entails extraction of the values, processing them with the statistical routine, and comparing reported values to calculated values. FIG. 2 shows the routine for checking statistical errors in documents 20. In the first step, a statistical operation is identified in the reported text. In the first step, a statistical operation is identified in the reported text. Next, the operation type and component values are determined, in this example, the Odds Ratio Test (OR) is said to have a confidence interval (CI) of 95%, with an OR value of 53.21, a CI lower bound: 4.3, and the CI upper bound: 15.73. Next, the values are recalculated, including the log-transform of all values, in which the transformed OR should be equal to the transformed CI upper-lower bound, which leads to the recalculation of the OR value=8.22, which is not the same as the text reviewed which showed an OR of 53.21, which is then reported as an error.

The process for checking for statistical errors 20 in documents, includes: (Step 22) Identify statistical operations reported in text (e.g., “respiratory symptoms were significantly higher in the affected population (OR=53.21; 95% CI=4.3-15.73)”); (Step 24) Determine operation type and component values (Type=odds ratio (OR) test with 95% confidence interval (CI), OR value: 53.21, CI lower bound: 4.3, CI upper bound: 15.73); (Step 26) Recalculate values (e.g., log-transform all values, transformed OR should be=to transformed CI upper-lower bound, Recalculated OR value=8.22, and/or Comparison: 8.22 is not equal to 53.21); and (Step 28) Report errors to user.

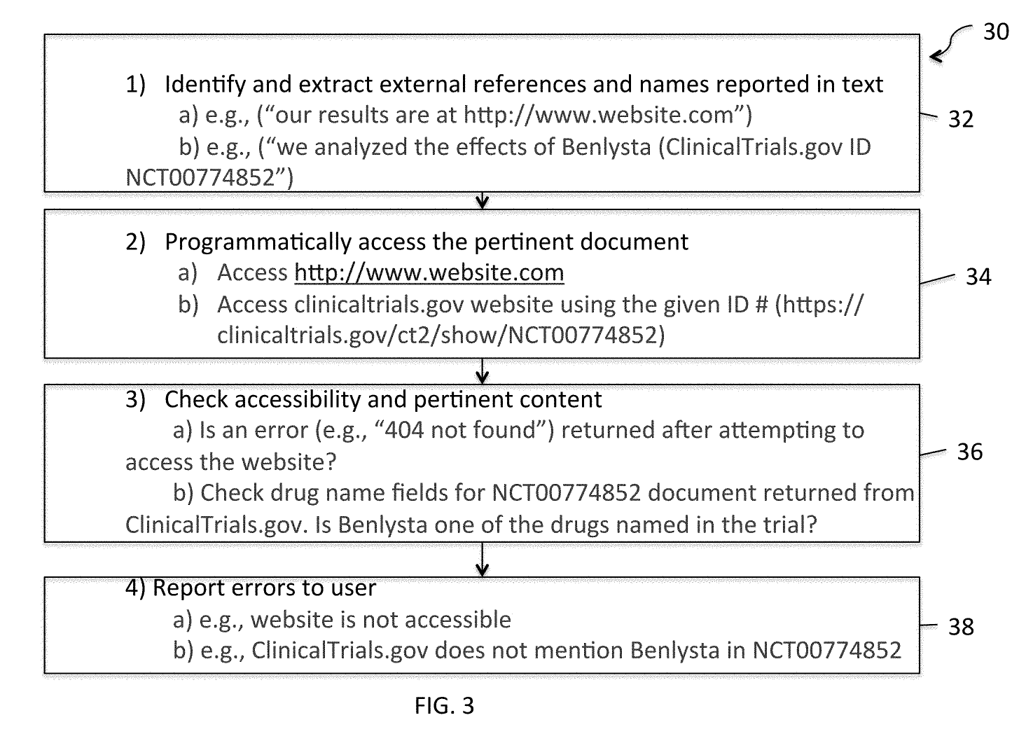

External reference (e.g., URL accessibility, DOI validity, clinical trials number): This type of error can be caught by consulting a source outside the paper to confirm it. This can be: (1) Confirmation of its existence (e.g., if a URL is accessible or if an email address is linked to an active account); (2) Confirmation of its correct format (e.g., DOI numbers have a pre-defined structure that, if not followed, would constitute an invalid DOI); or (3) Confirmation of its validity (e.g., a paper may say that drug X has clinical trials number Y, but a consultation of the clinical trials registry may show the given number Y is actually associated with drug Z, not drug X, and thus either the wrong number was provided or the wrong drug name was provided). FIG. 3 shows the routine for checking of errors in external references 30. In the first step, the various references are identified, in this example a URL and a ClinicalTrials.gov ID. Next, the pertinent website is accessed or a search for the document is conducted. Next, the accessibility and pertinent content is checked, leading in this example to an error message from the URL or the document is identified and the presence of the listed drug (Benlysta) is searched and not found. Finally, an error message is reported that shows an error in the URL or shows that the cited ClinicalTrials.gov ID is not related to the listed drug (Benlysta).

The process for errors in external references 30, includes: (Step 32) Identify and extract external references and names reported in text (e.g., (a) e.g., (“our results are at http://www.website.com”, and/or e.g., “we analyzed the effects of Benlysta (ClinicalTrials.gov ID NCT00774852”)); Programmatically access the pertinent document (e.g., Access http://www.website.com; Access clinicaltrials.gov web site using the given ID # (https://clinicaltrials.gov/ct2/show/NCT00774852); (Step 36) Check accessibility and pertinent content (e.g., (a) Is an error (e.g., “404 not found”) returned after attempting to access the website?, and/or (b) Check drug name fields for NCT00774852 document returned from ClinicalTrials.gov. Is Benlysta one of the drugs named in the trial?); and (Step 38) Report errors to user (e.g., (a) e.g., website is not accessible, and/or (b) e.g., ClinicalTrials.gov does not mention Benlysta in NCT00774852).

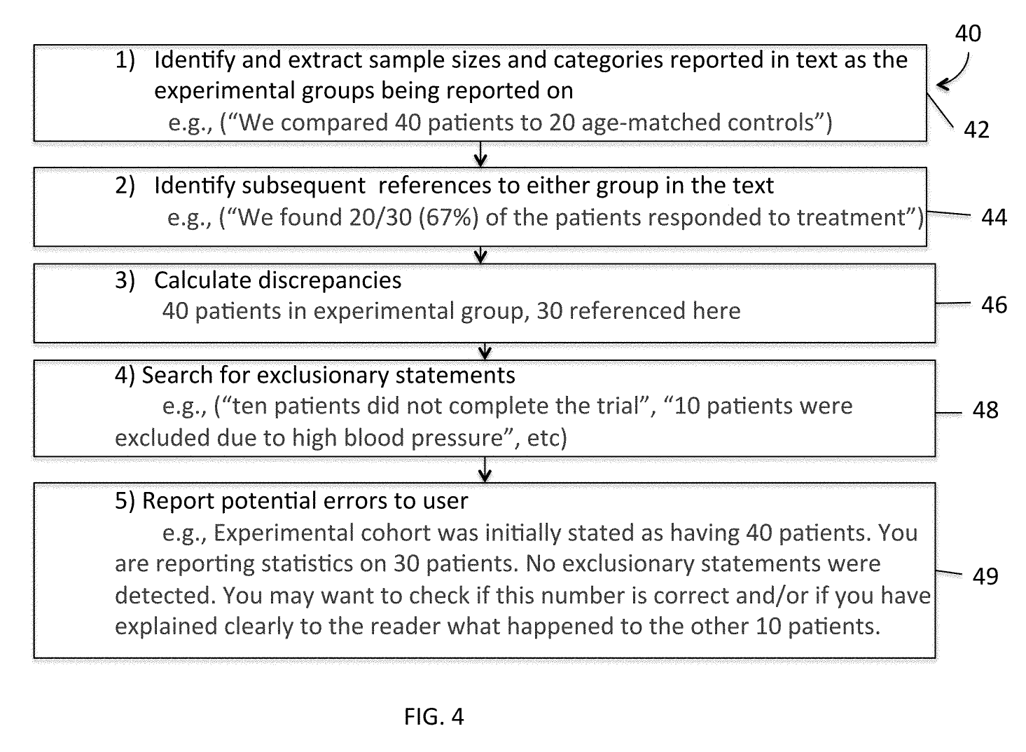

Consistency (e.g., number of people in a cohort): Sometimes a sample size will be stated early in the paper and referred to again throughout. A routine can check to ensure consistency of the numbers being referred to (e.g., it could be initially stated that there are 40 patients and 20 controls, but later in the paper 40 controls might be referred to, suggesting the authors confused the numbers). FIG. 4 shows the routine for checking for errors in consistency 40. First, the routine identifies and extracts sample sizes and categories reported in text as the experimental groups being reported on, e.g., the text reads “We compared 40 patients to 20 age-matched controls”). Next, subsequent references to either group are identified in the text, e.g., a separate location in the text states, “We found 20/30 (67%) of the patients responded to treatment”. Next, the two numbers are compared and the discrepancies calculated, e.g., 40 patients in experimental group, 30 referenced. Next, the routine searches for exclusionary statements, e.g., “ten patients did not complete the trial”, “10 patients were excluded due to high blood pressure”, etc. If none are found, then a report of a potential error is sent to the user, e.g.: Experimental cohort was initially stated as having 40 patients. You are reporting statistics on 30 patients. No exclusionary statements were detected. You may want to check if this number is correct and/or if you have explained clearly to the reader what happened to the other 10 patients.

The process for errors in consistency 40, including: (Step 42) Identify and extract sample sizes and categories reported in text as the experimental groups being reported on (e.g., (“We compared 40 patients to 20 age-matched controls”)); (Step 44) Identify subsequent references to either group in the text (e.g., (“We found 20/30 (67%) of the patients responded to treatment”)); (Step 46) Calculate discrepancies (e.g., 40 patients in experimental group, 30 referenced here); (Step 48) Search for exclusionary statements (e.g., (“ten patients did not complete the trial”, “10 patients were excluded due to high blood pressure”, etc.)); and (Step 49) Report potential errors to user (e.g., Experimental cohort was initially stated as having 40 patients. You are reporting statistics on 30 patients. No exclusionary statements were detected. You may want to check if this number is correct and/or if you have explained clearly to the reader what happened to the other 10 patients).

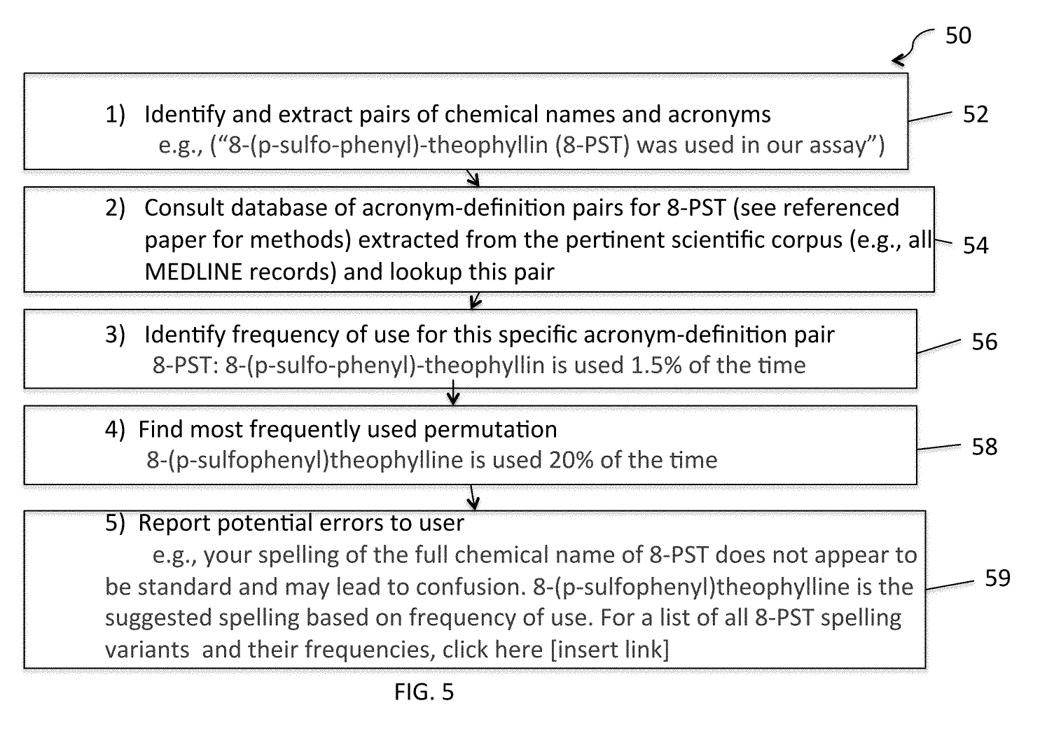

Standardization or conformity with best practice, including optimizing nomenclature and potential errors in nomenclature (e.g., avoiding uncommon, yet otherwise correct, chemical name spellings or gene names): Many chemical names will not be recognizable with standard spelling dictionaries, but will also have a degree of acceptable variation in their spelling (i.e., the spelling variants would be widely and unambiguously understood by other chemists which chemical is being referred to). But the less commonly used the spelling variation is, the more likely misunderstanding could occur and the odds that there may be problems with indexing (e.g., correctly assigning MeSH terms to papers in PubMed based upon entities mentioned in the paper) also increase. An error-checking routine, based on analysis of spelling variations found for the chemical name within the literature can be consulted to determine when the variation becomes so uncommon it is likely to be confusing (e.g., <5% of all instances). In some instances spelling variations may not be valid and lead to factual errors (e.g., misspelling an “imine” subgroup as “amine” results in a valid chemical name, but imines and amines are different chemical structures). These can be checked by pairing acronym abbreviations with their long form definitions, because acronyms for different chemical structures will normally differ themselves. Variation in chemical name spelling may also be sources of potential confusion for readers (e.g., some readers might infer that a chemical name beginning with “rho” really was supposed to begin with “p” (to indicate a para-substituted group), because the letter “p” looks similar to the Greek symbol for rho, but others may think it is a distinctly different chemical that is being referred to). In such cases, these would be flagged and reported to authors as part of the error-checking process to let them know that either a potential error exists or that the name is a statistically unusual variation that could cause confusion. FIG. 5 shows an example of the routine for checking for optimized nomenclature and potential nomenclature errors 50. First, names of chemical compounds and acronyms are identified, and pairs of the same are extracted, e.g., the text may read “8-(p-sulfo-phenyl)-theophyllin (8-PST) was used in our assay”. Next, one or more databases are consulted of acronym-definition pairs for 8-PST (see referenced paper for methods) extracted from the pertinent scientific corpus (e.g., all MEDLINE records) and this pair is looked up. Next, the frequency of use for this specific acronym-definition pair is identified, e.g., 8-PST: 8-(p-sulfo-phenyl)-theophyllin is used 1.5% of the time. Next, the most frequently used permutation is identified from the literature, e.g., 8-(p-sulfophenyl)theophylline may be the most commonly used name, 20% of the time. Finally, the potential error is reported to user, e.g., your spelling of the full chemical name of 8-PST does not appear to be standard and may lead to confusion. 8-(p-sulfophenyl)theophylline is the suggested spelling based on frequency of use. For a list of all 8-PST spelling variants and their frequencies, and a link is provided that the user can click [the software then inserts the link here].

The process for checking for optimized nomenclature and potential nomenclature errors 50, includes: (Step 52) Identify and extract pairs of chemical names and acronyms (e.g., (“8-(p-sulfo-phenyl)-theophyllin (8-PST) was used in our assay”); (Step 54) Consult database of acronym-definition pairs for 8-PST (see referenced paper for methods) extracted from the pertinent scientific corpus (e.g., all MEDLINE records) and lookup this pair; (Step 56) Identify frequency of use for this specific acronym-definition pair (e.g., 8-PST: 8-(p-sulfo-phenyl)-theophyllin is used 1.5% of the time); (Step 58) Find most frequently used permutation (e.g., 8-(p-sulfophenyl)theophylline is used 20% of the time); (Step 59) Report potential errors to user (e.g., your spelling of the full chemical name of 8-PST does not appear to be standard and may lead to confusion. 8-(p-sulfophenyl)theophylline is the suggested spelling based on frequency of use. For a list of all 8-PST spelling variants and their frequencies, click here [insert link]).

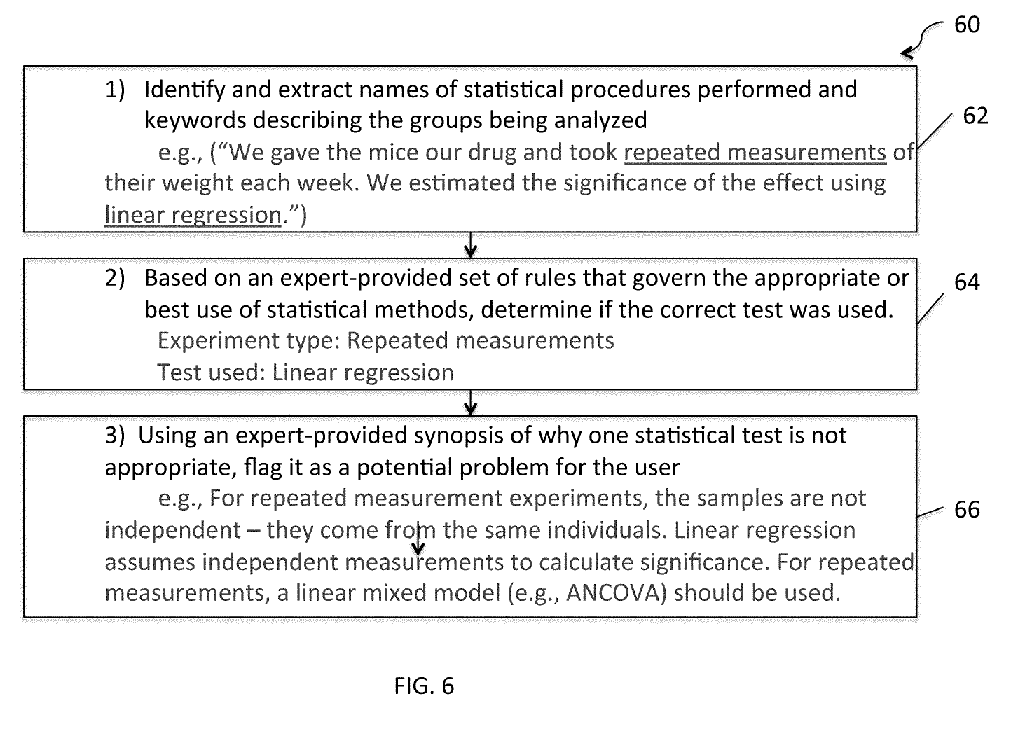

Appropriate use of statistical tests. The use of a statistical test to evaluate the significance of the results or the probability that a result could be due to chance is governed by a set of rules and assumptions. Different statistical tests are used depending upon the type of analysis being performed. Using an expert-provided set of “red flag” keywords/phrases and a thesaurus of statistical procedure names, the method can detect when an inappropriate statistical test may have been used. For example, ANOVA (ANalysis Of VAriance) is used to test whether or not a significant difference exists between two or more groups of measurements, whereas a t-test is used to compare two groups. If the document refers to a t-test being used to compare more than 2 groups, this would be flagged and reported. In some cases, the statistical test may be suboptimal (e.g., inaccurate but not necessarily wrong), while in other cases it may be completely inappropriate and yield incorrect results. The method, based on expert-provided input, can report the expert-estimated importance of the problem. FIG. 6 shows an example of a routine for checking for use of appropriate statistical methods 60. In the first step, the text is searched to identify and extract names of statistical procedures performed and keywords describing the groups being analyzed are determined, e.g., the text may read “We gave the mice our drug and took repeated measurements of their weight each week. We estimated the significance of the effect using linear regression.” Next, based on an expert-provided set of rules that govern the appropriate or best use of statistical methods, it is determined if the correct test was used. For example, experiment type: Repeated measurements and Test used: Linear regression are determined. Next, using an expert-provided synopsis of why one statistical test is not appropriate, the statistical method used is flagged as a potential problem for the user, e.g., the following report is generated “For repeated measurement experiments, the samples are not independent—they come from the same individuals. Linear regression assumes independent measurements to calculate significance. For repeated measurements, a linear mixed model (e.g., ANCOVA) should be used”. The “red flag” keywords can encompass both exact matches within the same sentence or in a nearby sentence (e.g., finding the exact phrase “repeated measurements”) or it could encompass a regular expression type search (e.g., “measurements were [taken/obtained] [each/every] [hour/day/week/month/year]”) whereby the bracketed words would be indicative of the different words that might be used, and the order in which they might be used, to represent the concept of repeated measurements grammatically. Or, Natural Language Processing (NLP) could be used (e.g., sentence diagramming) whereby the dependency between key concepts could be assessed (e.g., checking if the concepts of both time intervals and measurements are within the same sentence and then whether or not the concept of time intervals is specifically referring to the concept of measurements). The key concept behind this aspect of this part of the invention is that there are a finite number of ways within a given language that a concept (e.g., repeated measurements) associated with a named statistical test (which may also vary in the way it is spelled) is likely to be represented grammatically, and the specific algorithmic method used to identify when a concept refers to a statistical test is secondary to the idea that there are multiple ways this could be accomplished algorithmically.

The process for checking for use of appropriate statistical methods 60, includes: (Step 62) Identify and extract names of statistical procedures performed and keywords describing the groups being analyzed (e.g., (“We gave the mice our drug and took repeated measurements of their weight each week. We estimated the significance of the effect using linear regression.”)); (Step 64) Based on an expert-provided set of rules that govern the appropriate or best use of statistical methods, determine if the correct test was used (e.g., Experiment type: Repeated measurements, Test used: Linear regression); (Step 66) Using an expert-provided synopsis of why one statistical test is not appropriate, flag it as a potential problem for the user (e.g., For repeated measurement experiments, the samples are not independent—they come from the same individuals. Linear regression assumes independent measurements to calculate significance. For repeated measurements, a linear mixed model (e.g., ANCOVA) should be used).

EXAMPLE: The rate of errors published in MEDLINE abstracts decreases with increasing journal impact factor and number of authors.

The probability of author error, in general, is a function of task complexity, expertise, and re-checking the results. For an error to be published, it must also pass by peer-reviewers and editors. The efficiency of these error filters in MEDLINE publications was quantified by contrasting simple errors that require minimal technical expertise, such as accurately calculating a percent from a ratio, with calculations that require more expertise and processing steps, such as calculating 95% confidence intervals (CIs) and p-values for statistical ratios (Hazard Ratio, Odds Ratio, Relative Risk). Paired values were algorithmically extracted from abstracts, re-calculated, and compared, allowing for rounding and significant figures. A conservative definition of what constitutes a “discrepancy” was used to limit the analysis to items of potential interpretive concern. Over 486,000 analyzable items were identified within 196,278 abstracts. Per reported item, discrepancies were less frequent in percent-ratio calculations (2.7%) than in ratio-CI and p-value calculations (5.6% to 7.5%), and smaller errors were more frequent than large ones. The fraction of abstracts with systematic errors (multiple incorrect calculations of the same type) was higher for more complex tasks (14.3%) than simple (6.7%). Error rates decreased with increasing journal impact factor (JIF) and increasing number of authors, but with diminishing returns. It was found that 34% of the items wrongly reporting a significant p-value also had errors in the ratio-CI calculation versus 12% of the items wrongly reporting non-significant p-values, suggesting authors are less likely to question a positive result than a negative one.

Errors are part of the scientific experience, if not the human experience, but are particularly undesirable when it comes to reported findings in the published literature. Errors range in their severity from the inconsequential (e.g., a spelling error that is easily recognized as such) to those that affect the conclusions of a study (e.g., a p-value suggesting a result is significant when it is not). Some may be detectable based upon the text, while others may not. There has been a recent concern regarding scientific reproducibility 1, driven in part by reports of failures to replicate previous studies^{2,3}. Insofar as it is possible, by establishing base-line error rates for tasks, we can then prioritize which reported items are more likely to contain errors that might affect reproducibility. By understanding more about the types and nature of errors that are published, and what factors affect the rate of error commission and entry into the literature, we can not only identify ways to potentially mitigate them, but also identify where peer-review efforts are best focused.

Previous studies, largely from the Management literature, have established that there is a baseline human error rate in performing tasks, one that generally increases with the complexity of the task and decreases with task-taker expertise (Table 1). They have also found that people are generally worse at detecting errors made by others than they are in detecting their own errors, that errors of commission (e.g., calculating something wrong) are easier to detect than errors of omission (i.e., leaving important details out), and that errors in logic are particularly hard to detect (e.g., applying the wrong statistical test, or using the wrong variable in a standard formula that is otherwise correct in its calculations and structure)⁴.

TABLE 1
A sample of past studies documenting error rates, both with and without
the ability to self-correct one's errors. Tasks without the opportunity
to self-correct better approximate a base error rate related to the
relative complexity of the task, while those with the opportunity to
correct are more similar to a real-world scenario in which awareness
and ability to review will mitigate the base error rate.

| | Rate: | Reference |
|---|---|---|
| Spelling errors, with self-correction, | | |
| per: | | |
| Mail code entered | 0.5% | Baddeley & Longman¹⁰ |
| Word in text editor | 0.5% | Schoonard & Boies¹¹ |
| Word for an examination at Cambridge | 0.5% | Wing & Baddeley¹² |
| Keystroke for six expert typists | 1.0% | Grudin¹³ |
| Word from high-school essays | 2.4% | Mitton¹⁴ |
| Spelling errors, without self-correction, | | |
| per: | | |
| Word in text editor | 3.4% | Schoonard & Boies¹¹ |
| Keystroke from 10 touch typists | 4.0% | Mathias et al.¹⁵ |
| Nonword string in telecom devices for | 5.0% | Tsao¹⁶ |
| the deaf | | |
| Nonword string in telecom devices for | 6.0% | Kukich¹⁷ |
| the deaf | | |
| Nonsense word, from secretaries and | 7.4% | Mattson & Baars¹⁸ |
| clerks | | |

Thus, when compiling a body of work for publication, the user would expect errors to occur at a certain rate depending upon task complexity and author expertise, but in the context of peer-review and scientific publishing, there are several things not yet known. First, how does the number of co-authors affect the error rate? On one hand, more authors means more people potentially checking for errors, but it is possible that coordinating content authored by multiple people may increase the complexity of the task and, thus, the error rate. Second, how effective is peer-review at catching errors? It is generally believed that journal impact factor (JIF) correlates with the rigor of peer-review scrutiny, but this has not been quantitatively established, nor is it known how effective it is (i.e., whether the relationship is linear or there is a point of diminishing returns). There have been reports of journals with higher impact factors having higher retraction rates, and it has been argued that this, in part may be a consequence of the desire to publish the most striking results⁵, but this could also be due to increased scrutiny. Third, do factors such as peer-review or author number affect all error rates equally or does their impact depend on the type of error? Since expertise is a factor in detecting errors, it is possible that reviewers in some fields may be better at catching some types of errors and worse at others. Finally, what fraction of errors may be systematic in nature? These errors may be due to lack of expertise or may be due to the way calculations were set up (e.g., spreadsheets or programs referencing values encoded elsewhere rather than entering them directly). The odds of systematically incorrect calculations would seem more likely to affect the conclusions of the study than one random error. And a high systematic error rate would also suggest that the scientific community would benefit from a standardized solution/procedure designed to eliminate it.

In a previous study, the inventors surveyed URLs for their availability and found that 3.4% of them were inaccessible specifically because of errors in spelling/formatting, including 3% of Digital Object Identifiers⁶. Similarly, it was found that slightly less than 1% of published National Clinical Trial IDs led to an error page (but were unable to quantify how many may have been erroneous IDs that led to the wrong clinical trial)⁷. These were slightly unexpected because the inventors felt such items would be easy to “cut and paste”, but it speaks to the fact that we do not know the source of the errors nor can we assume that authors will approach tasks the same way. Similarly, other studies have found errors in reference formatting⁸, and a recent large-scale automated survey of the psychology literature for p-value errors reported in APA style found 12.9% with a gross inconsistency (error affecting significance at p<=0.05)⁹. The inventors identify published errors and see how additional scrutinizing factors such as rigor of peer-review and increasing number of authors affected the rate of errors becoming published. Similarly, the inventors wanted to approximate baseline error rates for these tasks and see whether error rates over time were relatively constant or if possibly technological advances might be impacting them, either positively (e.g., increased availability and ease of software packages) or negatively (e.g., by lack of standardization).

To answer these questions, the inventors focused on MEDLINE abstracts as an example because they tend to contain the most important findings of a study and, thus, errors in the abstract are more likely of potential concern. The inventors algorithmically scanned all MEDLINE abstracts to identify published percent-ratio pairs (e.g., “7/10 (70%)”), which are simple calculations requiring minimal expertise and for which tools (e.g., calculators) are ubiquitous. Complex calculations included the reporting of Odds Ratios (OR), Hazard Ratio (HR) and Relative Risk (RR) estimates along with their 95% Confidence Intervals (CI) and p-values when provided (e.g., OR=0.42, 95% CI=0.16-1.13, p<0.05). The inventors extracted their reported values, recalculated them based on the full set of reported numbers, then compared the recomputed values with the reported ones, looking for discrepancies. The error detection algorithm was based off of pattern-matching and had its own error rate, which may seem ironic, but it should be intuitive as to why this is the case. So we estimated its error rate by manually examining all instances where a 10% or greater discrepancy was found between the reported and re-calculated values. The inventors screened these algorithmic errors out as they were identified and used the error rate in this subset to estimate the number of false-positive errors between 1 and 10% (which were far more abundant and, thus difficult to screen manually). The inventors focused on extracting high-confidence patterns for this study, prioritizing a low false-positive (FP) rate over minimization of the false-negative (FN) rate.

The inventors did not want to count as “discrepancies” any instances that could be attributable to rounding differences (up or down) in the recalculated values, so the inventors based the calculations upon the number of reported significant figures in the primary item (OR/HR/RR). The inventors allowed for rounding in the CI as well, calculating a range of possible unrounded CI values, and only counted it as a discrepancy if it fell outside all possible rounding scenarios. The inventors divided errors into three categories based on the log 10 magnitude of discrepancy between the reported and re-calculated values: Potentially minor (≧1% and <10%), potentially serious (≧10% and <100%) and potentially egregious errors (≧100%). The inventors also identified “boundary violations”, which were those in which the ratio point estimator appeared outside of its CI (which should never happen), p-value errors in which the conclusion of significance would be changed at a level of p<0.05, and p-values that were an order of magnitude off in the wrong direction (e.g., reported p<0.001 but recalculated p<0.01). All reported values and their recomputed counterparts, along with PMID and the surrounding sentence context, are available upon request.

The MEDLINE database was downloaded from NCBI (http://www.ncbi.nlm.nih.gov/) on Apr. 26, 2016 in XML format and parsed to obtain the title, abstract, journal name and PubMed ID (PMID). Journal Impact Factors (JIFs) were obtained online for the year 2013. The 5-year JIF was used, as it should better reflect long-term JIF than the regular 2-year JIF, but 2-year JIF was used when the 5-year was not available. A total of 82,747 JIFs could not be mapped for the 486,325 analyzable items extracted (17%). This is a limitation of the study, as many of the journals that could not be mapped were low-impact journals.

Estimating the algorithmic error rate of extracting reported values. Each MEDLINE abstract was scanned for “analyzable items” (i.e., percent-ratio pairs, OR/HR/RR with paired 95% CIs, and p-values). The error-checking algorithm first used regular expressions to identify high-confidence instances of each analyzable item. For example, words that begin with parenthetical statements that include standard abbreviations (e.g., “(OR=” or “[RR=”) or their full forms (e.g., “(Odds Ratio=”) were then expanded to the next matching parenthesis, accounting for intermediate separators, and checked for the presence of a 95% CI or 95% CL (confidence limit) within. Then, a series of iterative filters reduced the widespread variability in reportable parameters (e.g., replacing CI(95) with 95% CI). Additional rules were applied to screen out false-positives (FPs). Since there is no gold standard for this type of analysis and over 486,000 items were analyzed, the inventors could not comprehensively evaluate the error rate. Instead the inventors focused on manual evaluation of errors ≧10% in all categories to estimate it. This was both to make the evaluation task tractable but, also, if no error was detected, it is far more likely the reported calculations are correct than it would be for calculations on erroneous numbers to yield a correct mathematical result. The inventors conducted several iterative rounds of algorithmic evaluation and improvement to reduce FPs and FNs before the final evaluation.

Point estimates of Odds Ratio (OR), Hazard Ratio (HR) and Relative Risk (RR) (aka “Risk Ratio”) were re-calculated by log-transforming the reported two-sided 95% confidence interval (CI) limits, then exponentiating the middle value. Standard statistical procedures for estimating such ratios (e.g., logistic regression) perform linearly into the log space, hence correct ratios should be equidistant from each log-transformed boundary of the two-sided CI (roughly 2 standard deviations in the case of 95% CIs). As such, the inventors relied upon the two reported CI limits for the calculations, assuming they were computed in log space and transformed back through exponentiation, hence positive. A number of reports had incomplete information such as no ratio being given despite the two CIs, only one CI limit provided (although surrounding context suggested two sided analysis). Some had mathematically incorrect values such as the CI limits being negative, suggesting either they were log-transformed but not explicitly declared as such, or a statistical procedure unsuitable for estimating ratios (e.g., standard linear regression) was used in estimation. These types of occurrences were considered either formatting errors or errors of omission and were not included in the estimates of errors of commission based upon reported value recalculations.

False negative rate assessment is difficult because it is hard to know, a priori, how many different possible ways such reported items could be phrased in text, and complicated by the fact that some items could not be analyzed due to formatting errors. But of the high-confidence “seed” patterns extracted for OR, HR and RR, only 2.4% did not meet at least one of the core requirements for recalculation of values (i.e., had a positive ratio and two positive CIs that were not expressed as a percent). There are certainly more total OR/HR/RR items within MEDLINE, but due to the complexities of semantic variation, the inventors restricted the analysis to the ones that the inventors could extract with high confidence.

Detecting percent-ratio errors. Ratios are often paired with percents (e.g., “ . . . 11/20 (55%) of our patients . . . ”) immediately proximal to each other in text. Correct identification of percent-ratio patterns had the largest error rate due to ratio-percent-like terms that were not actually numerator-denominator pairs (e.g., tumor grades, genotypes/ribotypes, visual acuity changes, and HPV types). The inventors found looking for papers with multiple items reported and a 100% error rate were effective ways to identify these exceptions and screen them out before the final run. The inventors flagged such keywords to subject these instances to higher scrutiny, but there were simply too many instances to investigate all estimated errors in detail. Thus, in this list, it is possible some patterns may be counted as percent-ratio errors, but may be a field-specific means of denoting something else and the inventors did not catch them. The inventors also did not try to infer meaning. For example, if an author wrote “the sequences were 99% ( 1/100) similar”, it could be reasonably inferred that the 1/100 referred to the mismatches found. However, such instances were rare and the general rule by far is that ratio-percent patterns like this are paired values, so it would be counted as a published error.

If the words preceding the ratio-percent pair indicated that it was greater than (e.g., “over”, “more than”) or less than (e.g., “under”, “less than”), then the inventors excluded that pattern from analysis under the presumption that it was not intended to be considered an exact calculation. Although most instances of these phrases did not have discrepancies, which suggest the authors were merely indicating the number was rounded, the inventors chose to err on the side of caution.

For ratio-percent pairs, one source of FPs that was extremely difficult to control for were anaphora-like references. That is, instances where the ratio preceding a percent is a subset of a larger number that was mentioned earlier in the sentence or abstract. For example, “We recruited 50 patients, but had to exclude ten of them, 6/10 (12%) because of prior illness and 4/10 (8%) because they were otherwise ineligible”—in this case the 12% and 8% refer to the 50 patients, not the ratios immediately preceding them. Because anaphora resolution is still a computationally difficult task, requires a different approach and cannot be properly benchmarked without a gold standard, and is relatively rare, the inventors chose to estimate the number of FPs caused by anaphora rather than try to correct it.

Extracting ratio-confidence interval pairs and associated values from text. OR, RR and HR reports most frequently followed the format “(R=X, 95% CI=L-U, p<C), where R is HR/RR/OR, X is the value for R, L is the lower CI boundary, U is the upper CI boundary, and C is the p-value (when given, which was approximately 33% of the time). The delimiters used to separate the values frequently varied, as did the order of the variables. Commas within numbers containing less than four digits were presumed to be decimals for the purpose of calculation (e.g., “CI=4,6-7,8”). Algorithmic error rates per extracted item were generally low (<=0.4%). The most frequent type of algorithmic error occurred when authors reported multiple items consecutively (e.g., “OR=4.3, 5.2, 6.1; 95% CI= . . . ”), but this was generally rare.

Re-calculation of reported ratio-CI values. Assuming standard statistical practices for estimating ratios (OR, RR and HR), the reported ratio should be equidistant from each confidence interval in log space. That is, it should equal the recalculated value X:

$$X = {10}^{( \frac{lo g ( L ) + lo g ( U )}{2} )} \qquad [ 1.1 ]$$

Where L and U are the lower and upper CI boundaries, respectively. Discrepancies between reported (R) and re-calculated (X) values were assessed by computing the relative difference:

$$\begin{matrix}diff = ( \frac{\vert X - R \vert}{min ( X , R )} ) & [ 1.2 ] \\ diff = {10}^{\vert ( lo g ( \frac{X}{R} ) ) \vert} - 1 & [ 1.3 ]\end{matrix}$$

Formula [1.2] is equivalent to taking the absolute log ratio and re-exponentiating it back to a percent value (formula [1.3]), to make differences symmetric. With the exception of p-values, discrepancies are presented as percent differences because they are more intuitive to interpret than log values.

Difference values were furthermore only counted if the calculated value fell outside the buffer range allowed by rounding the CI both up and down to the next significant digit. For example, if the reported CI was 1.1 to 3.1, then the ratio value was recalculated using a CI of 1.05-3.05 (the lowest it could have been prior to rounding up) and maximum of 1.15-3.15 (the highest it could have been prior to rounding down). Only when the reported ratio fell outside the range between the lowest and highest recalculated ratio values was it counted as a discrepancy and was presumed to be the lesser of the two rounding possibilities.

Recalculation of p-values for ratio-CI pairs. The inventors recalculated p-values based upon the confidence intervals (CIs), relying on the duality between the two sided CI region and the accepted region of a two-sided test with the same level of confidence. Again, the inventors assumed the reported figures were the result of standard practices in CI derivation and testing for ratios such as ORs: More specifically the inventors assumed the estimation uses the log-transformed space, the reference value of interest to compare an OR against is 1, and the reported p-value is the output of a two-sided test using this reference value as the null hypothesis and relying on the asymptotic normality of the log OR estimator. Some straightforward symbol manipulation in this context yields the p-value recalculation formula:

$$pval = 2 * Φ ( - \frac{q * \vert log U + log L \vert}{log U - log L} ) \qquad [ 1.2 ]$$

Where [L,U] are lower and upper reported CI limits for the OR, Φ is the Gaussian cumulative distribution function and q is the (1-alpha/2) Gaussian quantile for alpha at the CI significance level (e.g., q=1.96 for two sided 95% CI). While the above expression looks rather complex, there are instances were discrepancies between reported p-values and CI can be spotted right away, without any math, during the paper review: for example if the p-value shows significance at level alpha then the 1-alpha CI interval should not include the reference value 1 (and the opposite). Note the log OR estimator normality requires large samples, which is often the case in clinical and genetic studies (e.g., GWAS), and the inventors found ORs were commonly associated with these contexts. In any case, using the asymptotic normality assumption for small to moderate samples will lead to optimistic estimation of significance levels, and may underestimate the actual error rate in correct p-value calculations.

For simplicity, the inventors choose to ignore potential corrections for small samples such as using exact versions of the estimators or specialized tests for contingency tables (e.g., Fisher). Since the exact and the asymptotic tests should give similar results under ordinary situations, the inventors compensated by increasing the difference threshold between the reported and recomputed p-value considered to be an error.

Determination of discrepancies that constitute an “error” in p-values. One type of error is when the evaluation of significance at p<=0.05 is incorrect, whether reported as non-significant and re-calculated as significant or vice-versa. Magnitude discrepancies in p-values, in terms of whether or not it is potentially concerning, is probably best modeled in log terms, particularly since most tend to be very small numbers. For example, the percent difference between p=0.001 and p=0.002 might seem large, but would not likely be of concern in terms of how it might affect one's evaluation of the significance. But an order of magnitude difference between a reported p=0.001 and re-calculated p=0.01 suggests that the level of confidence has been misrepresented even if the significance at p<0.05 did not change. However, because there is also some point where order of magnitude differences also do not change confidence (e.g., p<1×10-20 vs p<1×10-19), the inventors limit order of magnitude analyses to values between p=1 and p<=0.0001. For the ratio-CI pairs extracted, this range represents about 98% of all reported p-values. Furthermore, under an assumption similar to rounding, p-value discrepancies are only counted as discrepancies if the recalculated value is higher when the authors report (p<X or p<X). If it is lower, it is presumed the authors reported a “capped” p-value to reflect precision limitations and all re-calculated values lower than this are counted as zero discrepancy. Similarly, if the authors report (p>X or p>X) and the re-calculated value is higher, it is not counted as a discrepancy. However, when the p-value is reported as exact (p=X), all discrepancies are counted.

After extracting p-values, the inventors found 15 were invalid; eight were >1 and seven <0, most of which appeared to be typos (e.g., the re-calculated p-values for those <0 matched their absolute value). A total of 704 were exactly zero, which goes against standard p-value reporting conventions, but many had their decimal points carried out further (e.g., p=0.000), suggesting a convention whereby the authors were indicating that the p-value was effectively zero, and that the precision of the estimate corresponded to the number of zeros after the decimal. So, in these cases, for analysis of discrepancies, the inventors added a 5 after the final zero (e.g., p<0.000 becomes p<0.0005), and 92.7% of the re-calculated p-values were on or below this modified number, suggesting it is a reasonable approximation. Also, 2,308 ratios had one CI exactly equal to 1, which suggests the possibility the significance calculation could have been with reference to one side of the interval only. For all values, when neither CI=1, the two-sided p-value is closer to the reported value 91% of the time. However, in cases with CI=1, the two-sided was closer 63% of the time. So for the CI=1 cases, if the one-sided recalculated p-value was closer to the reported value, the inventors assumed it was a one-sided test and used the one-sided p-value for discrepancy calculations. But, in these cases, the assumption of the ratio being equidistant from the CIs in log space is not necessarily true, so discrepancies were converted to null values because if the test was one-sided, the inventors do not know what the true value should be.

Identifying systematic errors. Errors could be the result of a mistake not easily attributed to any single cause, or they could be systematic in nature. For example, a problem either in the setup of calculations or the expertise of the authors may lend itself to repeated errors. For each abstract, the inventors calculated the p-value of finding X errors given Y analyzable items and the false discovery rate (FDR) for each item of the same type. Abstracts with only one reported item will not be able to have systematic (repeated) errors, so although FDRs were calculated for each abstract, the FDR for each abstract that only has one analyzable item will be 1. The inventors estimated systematic errors by summing the FDR over all abstracts with more than one analyzable item and dividing by the number of such abstracts, yielding an approximation of how many abstracts had systematic errors.

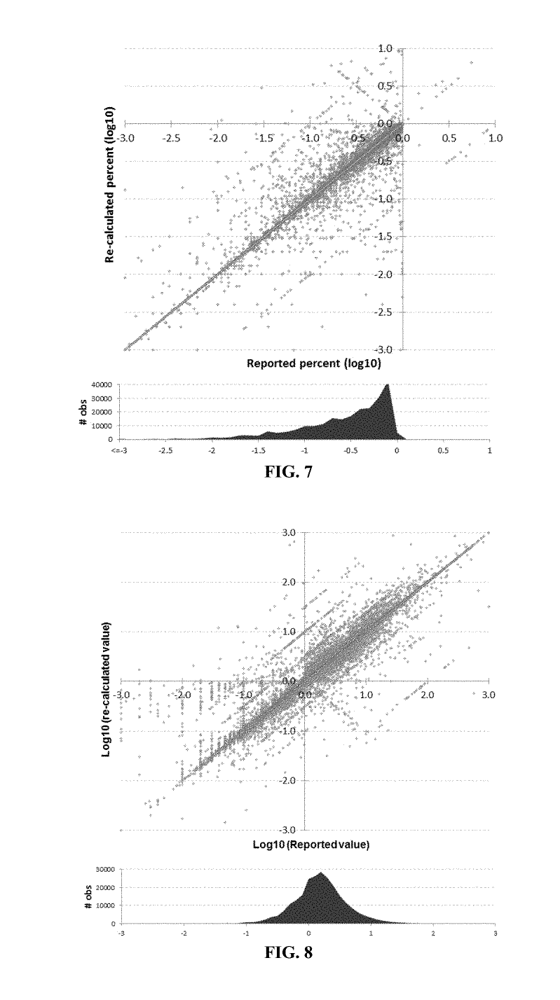

Results. A total of 486,325 analyzable items were extracted from within 196,278 unique abstracts across 5,652 journals. FIG. 7 shows discrepancies between reported and re-calculated percent-ratio pairs, while FIG. 8 gives an overview of the comparisons between all reported and recalculated ratio-CI values, scaled to their log 10 values. The main diagonal represents the instances where the recalculated values matched the reported values and, although the recalculation density is not evident in the plot, most (92.4%) had a discrepancy of 1% or less. Certain types of errors are also evident in these plots—seen as lines that parallel the main line. Those offset by a factor of 10 (1.0 in the log scale) are errors in which a decimal point was evidently omitted or misplaced in the ratio. The parallel lines between these lines are typically instances in which a decimal was omitted or misplaced in one or both CIs. In at least one identified decimal error (PMID 25034507), there is what appears to be a note from an author on the manuscript that apparently made it into the published version by accident whereby they ask “Is 270 correct or should it be 2.70” (it should have been 2.70). FIG. 9 shows the distribution of discrepancies found in Ratio-CI calculations, illustrating that smaller errors are more likely to be published than large ones, although a spike in those >=100% can be seen.

The inventors found that discrepancies in items that require more proficiency to accurately calculate and report (ratio-CI pairs) were more frequent in the published literature than errors that required minimal proficiency (percent-ratio pairs). Table 2 summarizes the error rates for each error type by magnitude. Large discrepancies were less frequent in all categories than smaller discrepancies. Interestingly, despite the calculation of 95% CIs for HR, RR and OR entailing essentially the same procedure, their error rates differed. Abstracts without discrepancies tended to have significantly more authors and were published in significantly higher impact journals.

TABLE 2
Reported values vs. recalculated values across order-of-magnitude
discrepancy ranges for each of the item types analyzed. “Ratio
outside CI” refers to instances in which the reported ratio
is not within the 95% CI boundaries, which should never happen.
“p-value errs” include both those that flip significance
at p <= 0.05 and those an order of magnitude off in the wrong direction.

| Reported vs. re- | Error rate per reported item | | | |
|---|---|---|---|---|
| calculated values | Pct-Ratio | HR | RR | OR |
| ≧100% discrepancy | 0.3% | 0.4% | 0.4% | 0.8% |
| ≧10% discrepancy | 1.2% | 2.4% | 2.9% | 3.5% |
| ≧1% discrepancy | 2.7% | 5.6% | 6.2% | 7.5% |
| p-value errors | | 3.9% | 5.8% | 6.0% |
| Ratio outside CI | | 0.4% | 0.4% | 0.6% |
| “Significant errors”* | 1.2% | 4.0% | 4.4% | 5.0% |
| t-test: # authors, errs | 2.6E−13 | 1.6E−05 | 6.4E−04 | 2.1E−09 |
| vs no errs** | | | | |
| t-test: JIF, errs vs no | 8.6E−08 | 2.6E−32 | 7.8E−06 | 2.1E−38 |
| errs** | | | | |
| Analyzable items | 241,571 | 43,468 | 32,769 | 168,517 |
| found: | | | | |
| Avg items/abstract: | 2.46 | 2.15 | 2.31 | 2.49 |

*Includes items with discrepancies ≧10%, ratios outside the CIs, and/or p-value errors. Shown also are t-test p-values regarding the probability the values came from the same distributions, with bold underlined font marking statistically significant p-values.
**comparing ≧10% discrepancy to no discrepancy

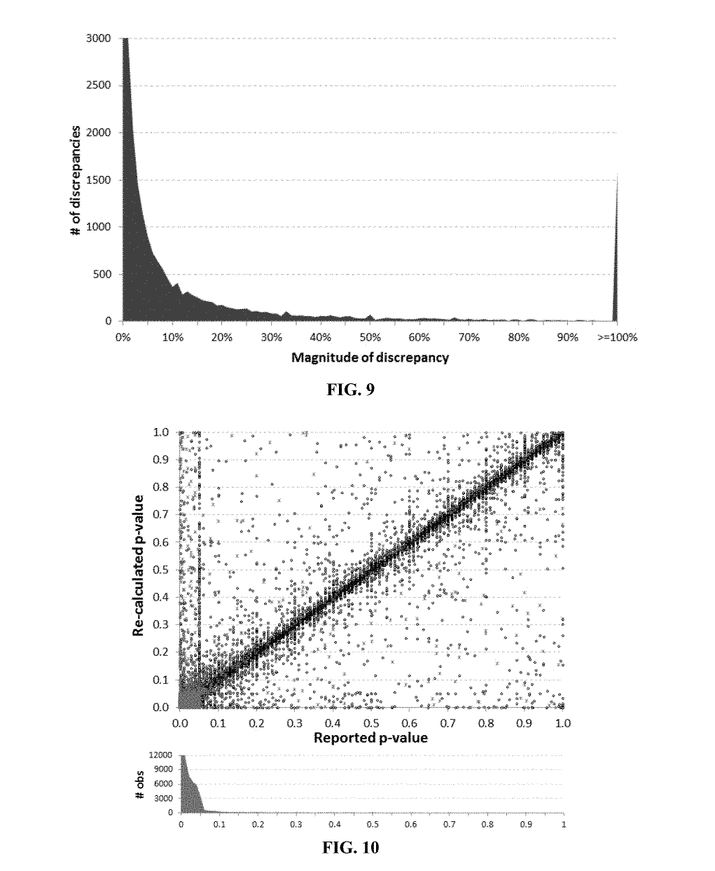

Reported versus recalculated p-values. A total of 81,937 p-values were extracted along with their ratio-CI pairs. The reported CIs were used to recalculate p-values using formula [1.1]. FIG. 10 shows a good general match between the re-calculated p-values and the reported p-values, focusing on the range 0-1. The inventors found a total of 1,179 (1.44%) re-calculated p-values would alter the conclusion of statistical significance at a cutoff of p≦0.05. The errors were slightly biased towards reported p-values being significant and the recalculated not significant (55%) as opposed to those reported not significant and re-calculated significant (45%). Interestingly, 34% of items with p-values erroneously reported as significant had ratio-CI errors versus only 15% of items with p-values erroneously reported as non-significant, which can be seen in FIG. 4. This suggests that authors may be less likely to question the validity of a result (i.e., double-check the calculations) when it reaches statistical significance versus one that does not.

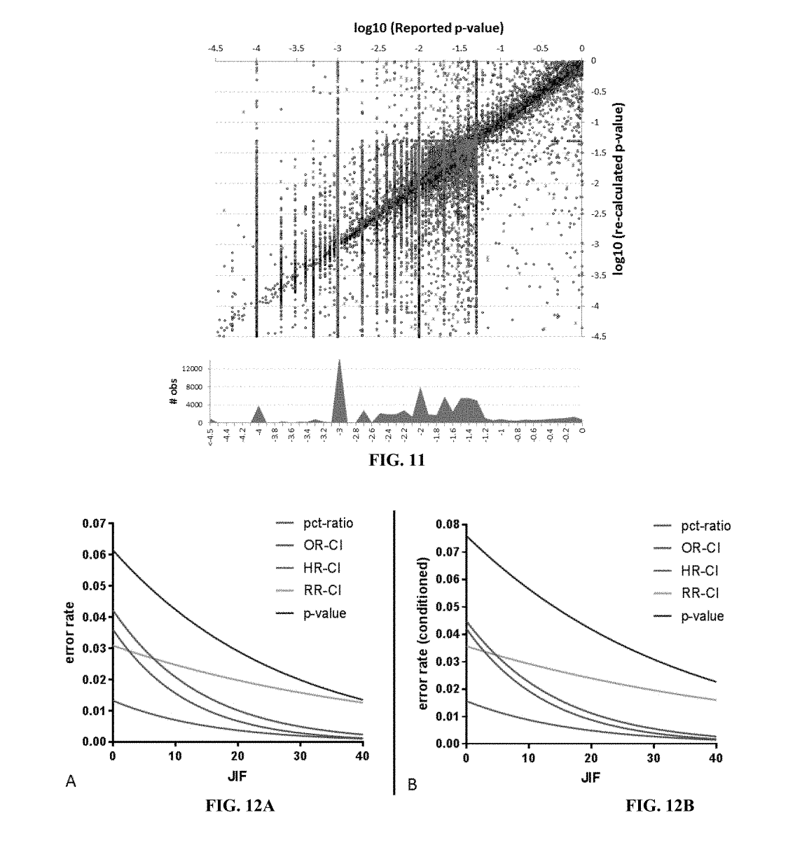

FIG. 11 shows the same analysis, but in log 10 scale, where certain features become evident. First, the tendency to round leads to a clustering of values within certain ranges. Second, the horizontal line of recalculated p-values that cluster at p=0.05 are mostly due to cases in which one CI=1, where a two-sided test under normal assumptions (see methods) would calculate precisely 95% of the values as above the no effect hypothesis (ratio=1.0). The inventors identified reported p-values off by at least one order of magnitude in the wrong direction (see methods). These are instances whereby the significance of the results may not change, but it could be argued the level of confidence was misrepresented or miscalculated. Rounding log 10 values to the nearest tenth of a decimal (e.g., 0.95 becomes 1.0), the inventors found 4.6% of reported p-values are off by at least one order of magnitude, and 1.0% are off by five or more orders of magnitude in the wrong direction. For further analysis, the inventors grouped both significance-flipping errors (at p<=0.05) and order of magnitude errors together into one “p-value error” category.

Higher JIF and number of authors per paper inversely correlate with error rate. Because very large studies tend to have large author lists and also tend to be published in higher impact journals, the inventors studied their joint impact on error rate with multiple logistic regression. Restricting analysis to errors ≧10% (“diff” in formula [1.1]), the results (Table 3) emphasize the significant reduction of error rate associated with increasing JIF and number of authors per paper, and that the author effect on error rate is generally independent of the JIF effect. Worth mentioning, the JIF effect on reported p-value errors is significant only when main effects are considered (p<0.02) and loses its significance (p=0.84) when interactions are considered in the model. This suggests the JIF effect on p-value errors is influenced by the tendency for papers in higher impact journals to have more authors.

TABLE 3
Joint dependence of error rate on Journal Impact Factor (JIF), number of authors and
their interaction. Values are the magnitude (the change in log odds ratio of error per
JIF/author) and the significance of the multiple logistic regression coefficients.

| Error Type | JIF effect | | # authors effect | | Interaction effect | |
|---|---|---|---|---|---|---|
| pct-ratio | −0.051 | (p < 0.0002) | −0.025 | (p < 0.008) | 0.001 | (p < 0.42) |
| OR-CI | −0.069 | (p < 2.90E−20) | −0.009 | (p < 0.09) | 0.001 | (p < 0.11) |
| RR-CI | −0.02 | (p < 0.017) | −0.025 | (p < 0.047) | 0.0009 | (p < 0.24) |
| HR-CI | −0.084 | (p < 4.7E−17) | −0.024 | (p < 0.0007) | 0.0025 | (p < 3.7E−08) |
| p-value | 0.0034 | (p < 0.84) | −0.13 | (p < 0.00001) | 0.0021 | (p < 0.1) |

Higher JIF and number of authors per paper inversely correlate with error magnitude. The inventors used smoothing splines to model the variation in the average magnitude of errors (“diff” in formula [1.1]) in each item type based on the publishing journal's impact factor (JIF) and number of authors respectively. When predicting the magnitude of reported errors based upon the JIF, the inventors observed a fairly sharp decrease at lower JIF, which then begins to level off (FIGS. 12A and 6B). Because papers with higher JIF also tend to have more authors, FIG. 12B shows the correlation between JIF and error rate when controlling for the number of authors per paper.

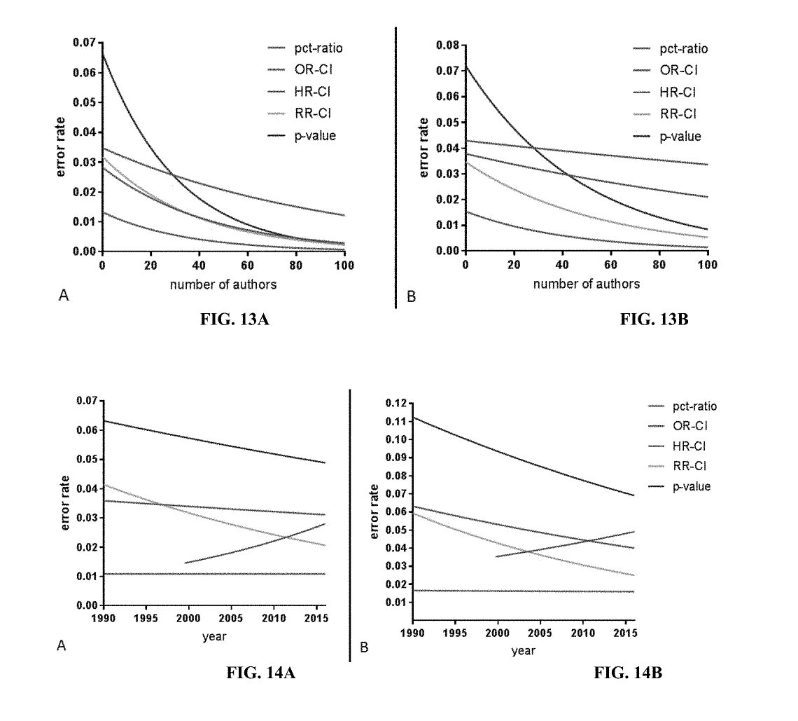

Interestingly, the magnitude of the effect JIF has on error rates is similar for most error types (except RR), and shows a diminishing rate of return as JIF increases. The inventors found a similar trend for the effect of the number of authors per paper (FIG. 13A and FIG. 13B), that error rate inversely correlates with the number of authors per paper for all error types. Whereas RR-CI rates were less influenced by JIF, the number of authors per paper had a higher effect on RR-CI error reduction. However, OR-CI error rates were less influenced by number of authors.

Error rates over the years. Error rate dependence on year of publication, per error type, is shown in FIGS. 14A and 14B. To determine the significance of the slopes, the inventors used logistic regression to control for author number and JIF. The inventors found percent-ratio errors did not significantly change with time (p<0.09), HR-CI errors are on the rise (p<0.02), while the other error types are on the decline (RR-CI, p<6.9E-10; OR-CI, p<4.5E-10; p-value errors, p<1.3E-06).

Abstracts with multiple errors. Some errors may not be easily attributed to a single cause, while others may be systematic in nature. For example, if the authors set up a general calculation procedure incorrectly such that the wrong numerator/denominator was used in all calculations, that could propagate errors to most or all of the reported results that relied upon it. Calculating p-values and false discovery rates for abstracts with multiple reportable items (see methods), the inventors estimated what fraction of errors might be systematic. Table 4 shows the results. Percent-ratio pairs had the lowest fraction of systematic errors, which seems reasonable since the number and complexity of calculations is low. Interestingly, RR had the highest fraction of systematic errors (20.2%).

TABLE 4
Estimation of the fraction of systematic errors among abstracts
with multiple items of the same type reported.

| | Pct-ratio | p-value | HR | OR | RR | weighted* |
|---|---|---|---|---|---|---|
| abstracts with >1 item | 58,788 | 21,367 | 11,645 | 42,549 | 8,318 | 83,879 |
| # with at least 1 error | 2,042 | 2,533 | 601 | 3,507 | 511 | 7,152 |
| % with at least 1 error | 3.5% | 11.9% | 5.2% | 8.2% | 6.1% | 8.5% |
| # with systematic errors | 137 | 310 | 87 | 525 | 103 | 1025 |
| (est) | | | | | | |
| % with systematic errors | 6.7% | 12.2% | 14.5% | 15.0% | 20.2% | 14.3% |

*weighted average is for “complex” item types (p-value, HR, OR, and RR) only.

The present inventors found that the probability an error will make it into the published literature correlates with the complexity of the task in constructing an analyzable item, the JIF of the publishing journal, and the number of authors per paper. Abstracts tend to report multiple calculations of the same mathematical/statistical nature, and papers even more, thus each new item increases the odds of at least one error in the paper. It is reasonable to presume that the inverse correlation between JIF and error rates reflects the effect of increasingly rigorous peer-review, whereby a baseline error for each reported item could be approximated by the least stringent review process (lowest JIF). However, it could also be argued that authors with greater proficiency in conducting calculations are more likely to produce reports of higher quality, which would tend to be accepted into higher JIF journals at a greater rate. Although the belief that peer-review rigor reduces error rates may be widely presumed to be true, this invention is the first to quantitatively establish it and show the rate of diminishing returns. The inventors also found that the more authors per paper, the less likely an error of the types analyzed will be published. Most studies to date have been concerned about the negative impacts of “author inflation”, but these suggest that there is a positive aspect to it as well.

Initially, it was not expected that error rates would significantly differ in the 95% CIs for OR, HR and RRs, because they essentially involve the same procedure and generally appear in medical journals and epidemiological studies. However, the inventors cannot measure author error rates directly, only errors published after peer-review. And, as the inventors have seen, each analyzed item type varied in the average number of authors per paper and average JIF in which it appears, so this may explain the differences in error rates for similar statistical procedures. Similarly, the inventors were somewhat surprised to see some error rates changing with time, but this may be in part explained by the changes in the average JIF and # of authors over time.

The distribution in the magnitude of errors also suggests that bigger errors are more likely to be noticed by either authors or reviewers than smaller ones. It's not clear at what point one might question the overall conclusions of a paper based upon a discrepancy, but the larger the discrepancy, the more concerning it is. And the fact that these discrepancies were found within the abstract, which usually recapitulates the most relevant findings of each paper, suggests they are more likely to be potentially problematic than had they been found in the full-text. At least 1,179 (1.44%) of recalculated p-values indicated that the assessment of statistical significance at p<=0.05 was incorrect, at least based upon the values reported. Although this frequency seems much lower than the 12.9% reported by Nuijten et al 9, their analysis was on a per-full-text paper basis, whereas ours is on a per-item basis. They report an average of 11 p-values found per paper so if the inventors presumed, roughly, the abstract-based per-item error rate of 1.44% extends to the probability of finding one erroneous item in the full paper, and that MEDLINE papers also have an average of 11 p-values per paper, then the inventors would have expected approximately 14.7% of papers to have one such error (0.985611=0.853). Thus, the estimates seem fairly consistent.

The source of the errors is unknown, but in cases where recalculated values differed by a factor of 10, the obvious conclusion is that a decimal place was somehow forgotten or misplaced. In a minority of cases where the abstract is obtained through optical character recognition (OCR), the numbers may not be correctly recognized. For example, in PMID 3625970 (published 1987), it reads “896% (25/29 infants)” in the MEDLINE abstract, but the scanned document online shows it actually reads “86% (25/29 infants)”. The rate of OCR error is unknown, but the inventors do not expect this would be a major confounding factor for this study. Electronic submission became widespread around 1997 and prior to this date, the number of errors ≧1% was 13.6% whereas it was 15% overall, suggesting that this period where OCR was more common does not have an appreciably higher error rate.

The inventors conducted this study using relatively conservative definitions of what constitutes a “discrepancy”, reasoning that most authors would prefer to be given the benefit of the doubt, particularly if knowledgeable readers understood that other factors (e.g., rounding, sig figs) might influence the precision of reported numbers and would be able to discern that a low-precision estimate on the threshold of significance is more problematic that one that is highly significant. However, it does lead to underestimation of the real error rate if adherence to field standards is the criteria for defining discrepancy. For example, 285 instances had a lower CI of exactly zero, which the inventors assumed is due to significant figure rounding, but it cannot be exactly zero. As a consequence, discrepancies within these items are generally higher (12.3% vs 7.0%) due to loss of precision. And, when the ratio-CI values are all very close to one, the benefit-of-the-doubt assumptions tend to be overly generous. For example, one of the more extreme cases is (OR=0.1, 95% CI=0.1-0.8) (PMID 19698821), Here, it is obvious correct calculations should not yield an OR equal one of the CIs, but with one significant figure reported, the allowance for the possibility the OR was calculated using pre-rounded CI values, and then permitting the authors to round the OR up or down, the recalculated OR value is 0.194 if the CI=0.05-0.75. Which, rounded down, is 0.1 and its recalculated discrepancy is zero. However, if the inventors increased stringency to capture more of these false-negatives, there will be other cases, specifically within this region close to 1.0, with relatively large percent discrepancies that might be an artifact of rounding and significant figure calculations that don't necessarily bear upon the validity of the results or prevalence of errors in general. This study is the first to estimate MEDLINE-wide rates of published errors within these five item types (HR, OR, RR, percent-division, p-values), and the inventors felt a lower-bound estimate of the true error rates would be the best place to start. And, because more items are reported in full-text papers, the per-paper error rate should be significantly higher than the per-item rate reported here.

The difficulty of a task is not always immediately obvious, but it correlates strongly with the probability that an error will be made, and it's reasonable to expect that this phenomenon likely extends to all reportable item types that process raw data through procedures and calculations, not just the ones the inventors analyzed here. It is true for experimental procedures as well, but positive and negative controls mitigate the problem there, whereas statistical reporting does not normally include control calculations. The inventors found that for the ratio-CI statistical pairs, the fundamental calculations underlying the estimation of a 95% CI are quite similar, but the rates of published errors among them differ in several ways, even after controlling for the effects of JIF and author number.

By identifying paired values, the inventors were able to reverse-engineer the calculations to identify potential discrepancies. With the exception of decimal discrepancies, the inventors cannot say which of the paired values was incorrect. But having some way to double-check reported values is important for scientific reproducibility. Along those lines, this study focused on errors of commission (i.e., incorrect calculations) and not errors of omission (i.e., leaving out relevant details). The inventors did see instances where ratio reports were missing key values, such as only reporting one CI, not mentioning the percentile of the CI, and not reporting the CI at all. And although one CI could be inferred from the other and 95% could be reasonably assumed as the default CI, this reduces the rigor and fidelity of attempts to reproduce the calculations.

Minimizing published errors is a priority, not just to ensure public confidence in science and protect the integrity of the own reports, but because the inventors rely upon published findings to establish facts that often serve as the foundation for the hypotheses, experiments and conclusions. Ultimately, an understanding of what types of errors make it into the published record and what factors tend to affect the published error rate will not only help guide efforts to mitigate errors, but will help quantify the complexity of certain tasks and identify problem areas that may merit increased scrutiny during peer-review.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), propertie(s), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

### REFERENCES

Chemical name variation and the effects it has on MeSH term indexing in PubMed: Wren JD “A scalable machine-learning approach to recognize chemical names within large text databases” BMC Bioinformatics 2006 Sep. 6; 7(Suppl 2): S3.
URL decay in MEDLINE: Wren JD “404 Not Found: The Stability and Persistence of URLs Published in MEDLINE” Bioinformatics 2004 Mar. 22; 20(5):668-72.
Errors in DOI links: Hennessey J, Georgescu C, Wren JD “Trends in the Production of Scientific Data Analysis Resources” BMC Bioinformatics 2014 Oct. 21, 15(Suppl 11):57.

### REFERENCES—EXAMPLE

1 Collins, F. S. & Tabak, L. A. Policy: NIH plans to enhance reproducibility. Nature 505, 612-613 (2014).
2 Prinz, F., Schlange, T. & Asadullah, K. Believe it or not: how much can we rely on published data on potential drug targets? Nature reviews. Drug discovery 10, 712, doi:10.1038/nrd3439-cl (2011).
3 Begley, C. G. & Ellis, L. M. Drug development: Raise standards for preclinical cancer research. Nature 483, 531-533, doi:10.1038/483531a (2012).
4 Allwood, C. M. Error Detection Processes in Statistical Problem Solving. Cognitive Science 8, 413-437 (1984).
5 Fang, F. C. & Casadevall, A. Retracted science and the retraction index. Infection and immunity 79, 3855-3859, doi:10.1128/IAI.05661-11 (2011).
6 Hennessey, J., Georgescu, C. & Wren, J. D. Trends in the production of scientific data analysis resources. BMC bioinformatics 15 Suppl 11, S7, doi:10.1186/1471-2105-15-S11-S7 (2014).
7 Wren, J. D. Clinical Trial IDs need to be validated prior to publication because hundreds of invalid NCTIDs are regularly entering MEDLINE. Clinical Trials (in press) (2016).
8 Aronsky, D., Ransom, J. & Robinson, K. Accuracy of references in five biomedical informatics journals. Journal of the American Medical Informatics Association: JAMIA 12, 225-228, doi:10.1197/jamia.M1683 (2005).
9 Nuijten, M. B., Hartgerink, C. H., van Assen, M. A., Epskamp, S. & Wicherts, J. M. The prevalence of statistical reporting errors in psychology (1985-2013). Behavior research methods, doi:10.3758/s13428-015-0664-2 (2015).
10 Baddeley, A. D. & Longman, D. J. A. The Influence of Length and Frequency of Training Session on the Rate of Learning to Type. Ergonomics 21, 627-635 (1978).
11 Schoonard, J. W. & Boies, S. J. Short Type: A Behavior Analysis of Typing and Text Entry. Human Factors 17, 203-214 (1975).
12 Wing, A. M. & Baddeley, A. D. Spelling Errors in Handwriting: A Corpus and Distributional Analysis. 251-285 (Academic Press, 1980).
13 Grudin, J. Error Patterns in Skilled and Novice Transcription Typing. 121-143 (Springer Verlag, 1983).
14 Mitton, R. Spelling Checkers, Spelling Correctors, and the Misspellings of Poor Spellers. Information Process Management 23, 495-505 (1987).
15 Matias, E., MacKenzie, I. S. & Buxton, W. One-Handed Touch Typing on a QUERTY Keyboard. Human-Computer Interaction 11, 1-27 (1996).
16 Tsao, Y. C. in Proceedings of the 13th International Symposium on Human Factors in Telecommunications.
17 Kukich, K. Techniques for Automatically Correcting Words in Text. ACM Computing Surveys 24, 377-436 (1992).
18 Mattson, M. & Baars, B. J. Error-Minimizing Mechanisms: Boosting or Editing. 263-287 (Plenum, 1992).

What is claimed is:

1. A computerized method for determining errors within the text of a file in electronic format, the method comprising:
obtaining an electronic file of the text;
identifying one or more possible errors in the electronic file using a processor;
sorting the possible errors in the electronic file into one or more error categories;
based on the error category, performing one or more of the following: (1) calculations on provided numbers for mathematical errors, (2) checking at least one of the status, availability, or key content accuracy of cited external references, (3) checking a name or reference to a statistical test performed, extracting the reported values and re-conducting the statistical test to compare the accuracy of the re-calculated values with the reported values, (4) determining consistent use of terminology, (5) comparing nomenclature employed in the document with at least one of a standardized nomenclature or a commonly employed nomenclature, or (6) identifying an appropriate use of statistical tests and methods;
sorting possible errors into confirmed errors or corrected values for each possible error; and
at least one of storing or displaying the confirmed errors.

2. The method of claim 1, wherein the step of performing calculations on numerical errors is defined further as comprising identifying a set of numbers or terms reported in the electronic file, determining a mathematical relationship between the set of numbers or terms, and re-calculating the values of a set of numbers or terms reported in the electronic file, wherein a discrepancy in the calculation causes the possible error to become a confirmed numerical error.

3. The method of claim 1, wherein the step of performing statistical calculations by checking a reported number in relation to its confidence interval, extracting values, and processing them with the statistical routine, and comparing reported values to calculated values, wherein a discrepancy in the statistical calculation causes the possible error to become a confirmed statistical calculation error.

4. The method of claim 1, wherein the step of performing the step of checking at least one of the status, availability, or key content accuracy of cited external references includes one or more of the following: URL accessibility, DOI validity, clinical trials number existence and accuracy, wherein a discrepancy in the availability of the cited external references causes the possible error to become a confirmed cited external references calculation error.

5. The method of claim 1, wherein the step of checking at least one of the status, availability, or key content accuracy of cited external references may further include one or more of the following: confirmation of the existence of the external reference; confirmation of the correct format of the external reference; or confirmation of the validity of the cited portion of the text of the external reference.

6. The method of claim 1, wherein the step of determining consistent use of terminology comprises determining consistent numbers associated with terms related to sample size, cohorts, controls, wherein a discrepancy in the availability of the consistent use of terminology causes the possible error to become a confirmed cited external references calculation error.

7. The method of claim 1, wherein the step of comparing nomenclature employed in the document with at least one of a standardized nomenclature or a commonly employed nomenclature is defined further as determining standardization or conformity with best practices in chemical names, non-standard gene names, and indexing, and calculating a degree of acceptable variation in their spelling, wherein a discrepancy in the availability of the consistent use of nomenclature causes the possible error to become a confirmed cited external references calculation error.

8. The method of claim 1, wherein the step of performing calculations on provided numbers for mathematical errors is defined further as comprising identifying a set of numbers or terms reported in the electronic file, determining a mathematical relationship between the set of numbers or terms, and re-calculating the values for set of numbers or terms reported in the electronic file, wherein a discrepancy in the calculation causes the possible error to become a confirmed numerical error.

9. The method of claim 1, wherein the step of checking the name or reference to a statistical test performed, extracting the reported values and re-conducting the statistical test to compare the accuracy of the re-calculated values with the reported values is defined further as checking a reported number in relation to its confidence interval, extracting values, and processing them with the statistical routine, and comparing reported values to calculated values, wherein a discrepancy in the statistical calculation causes the possible error to become a confirmed statistical calculation error.

10. The method of claim 1, wherein the step of determining the appropriate use of statistical tests is defined further as obtaining an expert-provided set of keywords/phrases of statistical test and a thesaurus of statistical procedure names, and detecting when an inappropriate statistical test was used based on a comparison of the text of the document, the keywords/phrases of statistical test and the thesaurus of statistical procedure names.

11. A non-transitory computer readable medium for determining errors within a text file in an electronic format or an image of a file and converting it into electronic format, comprising instructions stored thereon, that when executed by a computer having a communications interface, one or more databases and one or more processors communicably coupled to the interface and one or more databases, perform the steps comprising:
obtaining from the one or more databases an electronic file of the text file;
identifying one or more possible errors in the electronic file using a processor;
sorting the possible errors in the electronic file into one or more error categories;
performing one or more of the following: (1) calculations on provided numbers for mathematical errors, (2) checking at least one of the status, availability, or key content accuracy of cited external references, (3) checking a name or reference to a statistical test performed, extracting the reported values and re-conducting the statistical test to compare the accuracy of the re-calculated values with the reported values, (4) determining consistent use of terminology, (5) comparing nomenclature employed in the document with at least one of a standardized nomenclature or a commonly employed nomenclature, or (6) identifying an appropriate use of statistical tests;
sorting possible errors into confirmed errors or corrected values for each possible error; and
at least one of storing or displaying the confirmed errors.

12. The non-transitory computer readable medium of claim 11, wherein the step of performing calculations on numerical errors is defined further as comprising identifying a set of numbers or terms reported in the electronic file, determining a mathematical relationship between the set of numbers or terms, and re-calculating the values of a set of numbers or terms reported in the electronic file, wherein a discrepancy in the calculation causes the possible error to become a confirmed numerical error.

13. The non-transitory computer readable medium of claim 11, wherein the step of checking a reported number in relation to its confidence interval, extracting values, and processing them with the statistical routine, and comparing reported values to calculated values, wherein a discrepancy in the statistical calculation causes the possible error to become a confirmed statistical calculation

14. The non-transitory computer readable medium of claim 11, wherein the step of checking at least one of the status, availability, or key content accuracy of cited external references includes one or more of the following: URL accessibility, DOI validity, clinical trials number existence and accuracy, wherein a discrepancy in the availability of the cited external references causes the possible error to become a confirmed cited external references calculation error.

15. The non-transitory computer readable medium of claim 11, wherein the step of checking at least one of the status, availability, or key content accuracy of cited external references may further include one or more of the following: confirmation of the existence of the external reference; confirmation of the correct format of the external reference; or confirmation of the validity of the cited portion of the text of the external reference.

16. The non-transitory computer readable medium of claim 11, wherein the step of determining consistent use of terminology comprises determining consistent numbers associated with terms related to sample size, cohorts, controls, wherein a discrepancy in the availability of the consistent use of terminology causes the possible error to become a confirmed cited external references calculation error.

17. The non-transitory computer readable medium of claim 11, wherein the step of comparing nomenclature employed in the document with at least one of a standardized nomenclature or a commonly employed nomenclature is defined further as determining standardization or conformity with best practices in chemical names, non-standard gene names, and indexing, and calculating a degree of acceptable variation in their spelling, wherein a discrepancy in the availability of the consistent use of nomenclature causes the possible error to become a confirmed cited external references calculation error.

18. The non-transitory computer readable medium of claim 11, wherein the step of performing calculations on provided numbers for mathematical errors is defined further as comprising identifying a set of numbers or terms reported in the electronic file, determining a mathematical relationship between the set of numbers or terms, and re-calculating the values for set of numbers or terms reported in the electronic file, wherein a discrepancy in the calculation causes the possible error to become a confirmed numerical error.

19. The non-transitory computer readable medium of claim 11, wherein the step of checking the name or reference to a statistical test performed, extracting the reported values and re-conducting the statistical test to compare the accuracy of the re-calculated values with the reported values is defined further as checking a reported number in relation to its confidence interval, extracting values, and processing them with the statistical routine, and comparing reported values to calculated values, wherein a discrepancy in the statistical calculation causes the possible error to become a confirmed statistical calculation error.

20. The non-transitory computer readable medium of claim 11, wherein the step of converting the image of a file into an electronic format is by object character recognition.

21. The non-transitory computer readable medium of claim 11, wherein the step of converting the image of a file into an electronic format is by object character recognition in which the language of the publication is first detected, and once the language is identified performing object character recognition for that language.

22. The non-transitory computer readable medium of claim 11, wherein the step of determining the appropriate use of statistical tests is defined further as obtaining an expert-provided set of keywords/phrases of statistical test and a thesaurus of statistical procedure names, and detecting when an inappropriate statistical test was used based on a comparison of the text of the document, the keywords/phrases of statistical test and the thesaurus of statistical procedure names.
